(19) United States
(12) Patent Application Publication
(10) Pub. No.: US 2009/0206978 A1
(43) Pub. Date: Aug. 20, 2009

(54) Electrical fuse device including a fuse link

(76) Inventors: Soo-Jung Hwang, Seoul (KR); Deok-kee Kim, Seoul (KR); Jung-hun Sung, Yongin-si (KR); I-hun Song, Seongnam-si (KR); Hyuk-soon Choi, Seongnam-si (KR)

Correspondence Address: HARNESS, DICKEY & PIERCE, P.L.C., P.O. BOX 8910, RESTON, VA, 20195, US

(21) Appl. No.: 12/379,347

(22) Filed: Feb. 19, 2009

(30) Foreign Application Priority Data
Feb. 20, 2008 (KR) 10-2008-0015468

(51) Int. Cl. H01H 85/10

(52) U.S. Cl. 337/295

(57) ABSTRACT

Example embodiments relate to an electrical device, for example, to an electrical fuse device that includes a fuse link for linking a cathode and anode. An electrical device may include a cathode, an anode, and a fuse link. The fuse link may link the cathode and the anode. The fuse link may include a multi-metal layer structure. The fuse link may include a first metal layer including a first resistance, and a second metal layer stacked on the first metal layer and including a second resistance. The first resistance may be different from the second resistance. The fuse link may include a weak point as a region at which electrical blowing is performed easier than other regions of the fuse link.

### PRIORITY STATEMENT

This U.S. non-provisional patent application claims the benefit of Korean Patent Application No. 10-2008-0015468, filed on Feb. 20, 2008, in the Korean Intellectual Property Office, the disclosure of which is incorporated herein in its entirety by reference.

### BACKGROUND

1. Field

Example embodiments relate to an electrical device, for example, to an electrical fuse device that includes a fuse link for linking a cathode and anode.

2. Description of the Related Art

A fuse device may be used in semiconductor memory devices or logic devices for various purposes, such as repairing a defective cell, storing chip identification (ID) and/or circuit customization, for example. Memory cells in a memory device determined as defective may be replaced with redundancy cells. Each redundancy cell may include a fuse device.

A fuse device may include a laser-blown type and an electrically-blown type. The laser-blown type fuse device may use a laser beam to blow a fuse line. However, when irradiating the laser beam to a particular fuse line, fuse lines adjacent to the particular fuse line and/or other devices may be damaged. In contrast, the electrically-blown type of fuse device may apply a programming current to a fuse link such that the fuse link is blown due to an electromigration (EM) effect and a Joule heating effect, for example.

A conventional electrically-blown type fuse device may include a silicon-based fuse link. However, for higher integration and/or lower power consumption of a semiconductor device, the configuration of the conventional electrically-blown type fuse device may need to be improved.

### SUMMARY

According to example embodiments, an electrical fuse device may include a cathode, an anode, and a fuse link. The fuse link may link the cathode and the anode. The fuse link may include a multi-metal layer structure.

The fuse link may include a first metal layer that has a first resistance and a second metal layer that has a second resistance. The second metal layer may be stacked on the first metal layer. The resistance of the first metal layer may be different from the resistance of the second metal layer.

One of the first metal layer and the second metal layer, having a lower resistance than the other one, may include one of a W (tungsten) layer, an Al (aluminum) layer, and a Cu (copper) layer. The other one of the first metal layer and the second metal layer, having a higher resistance than the one, may include one of a Ti (titanium) layer, a TiN (titanium nitride) layer, and a TaN (tantalum nitride) layer.

A structure of the cathode and the anode may include the multi-metal layer structure. Also, the fuse link may include a weak point. The weak point may be a region at which electrical blowing is performed easier than other regions of the fuse link. The weak point may include a first notch and a second notch, where the first and second notches may be on each side of the fuse link. Also, the first and second notches may be diagonally opposite to each other. The weak point may be closer to the cathode than to the anode. Alternatively, the weak point may be a bent region. The weak point may have a width smaller than the widths of the other regions of the fuse link.

The cathode and the anode may include a structure in which electromigration from the fuse link to the anode is performed easier than that from the cathode to the fuse link. Portions of the cathode may extend towards the anode, where the portions of the cathode may be at both sides of the fuse link. Also, the anode may include a first region linked to the fuse link, where the width of the first region may gradually increase away from the boundary between the fuse link and the first region. The anode may further include a second region extending from the first region. The shape of the anode may be a rectangle with a fixed width

According to example embodiments, an electrical fuse device may include a cathode and an anode formed apart from each other, and a fuse link linking the cathode and the anode. The fuse link may include a weak point as a region at which electrical blowing is performed easier than other regions of the fuse link. The weak point may be closer to the cathode than to the anode.

The weak point may have a width smaller than the widths of the other regions of the fuse link. The weak point may be a bent region. The cathode and the anode may have a structure in which electromigration from the fuse link to the anode is performed easier than that from the cathode to the fuse link. Portions of the cathode may extend toward the anode, where the portions of the cathode may be at both sides of the fuse link.

The anode may include a first region linked to the fuse link, where the width of the first region may increase away from a boundary between the fuse link and the first region. The anode may further include a second region extending from the first region. The shape of the anode may be a rectangle with a fixed width.

### BRIEF DESCRIPTION OF THE DRAWINGS

The above and other features and advantages will become more apparent by describing in detail example embodiments thereof with reference to the attached drawings in which:

FIG. 1A is a plan view of an electrical fuse device according to example embodiments;

FIG. 1B is a cross-sectional view of an electrical fuse device obtained along line I-I′ of FIG. 1A according to example embodiments;

FIG. 2A-2C is a cross-sectional view of an electrical fuse device illustrating an operation for blowing a electrical fuse device, according to an example embodiment;

FIG. 3 is a plan view of an electrical fuse device according to example embodiments;

FIG. 4 is a plan view of an electrical fuse device according to another example embodiment;

FIG. 5 is a plan view of an electrical fuse device according to another example embodiment; and

FIGS. 6 and 7 are plan views of fuse links included in electrical fuse devices, according to example embodiments.

### DETAILED DESCRIPTION

Detailed example embodiments are disclosed herein. However, specific structural and functional details disclosed herein are merely representative for purposes of describing example embodiments. Accordingly, example embodiments are capable of various modifications and alternative forms. It should be understood, however, that there is no intent to limit example embodiments to the particular forms disclosed, but on the contrary, example embodiments are to cover all modifications, equivalents, and alternatives falling within the scope of the application.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used here, the term “and/or” includes any and all combinations of one or more of the associated listed items.

The terminology used herein is for the purpose of describing particular embodiments only and is not intended to be limiting. As used there, the singular forms “a”, “an”, and “the” are intended to include the plural forms as well, unless the context clearly indicates otherwise. It will be further understood that the terms “comprises”, “comprising”, includes” and/or “including”, when used herein, specify the presence of stated features, integers, steps, operations, elements, and/or components, but do not preclude the presence or addition of one or more other features, integers, steps, operations, elements, components, and/or groups thereof.

Example embodiments will now be described more fully with reference to the accompanying drawings. This invention, however, may be embodied in many different forms and should not be construed as limited to example embodiments set forth herein. Rather, example embodiments are provided so that his disclosure will be thorough and complete, and will fully convey the scope of the application to those skilled in the art. In the drawings, like numbers refer to like elements throughout.

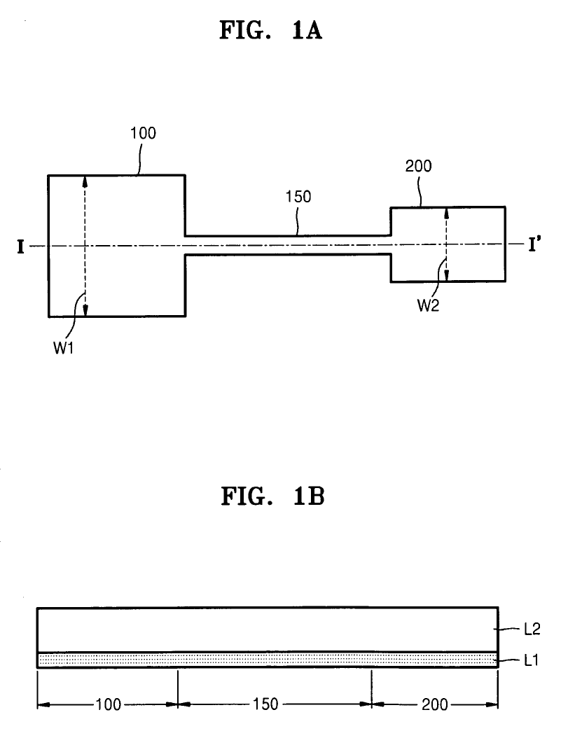

FIG. 1A is a plan view of an electrical fuse device according to example embodiments, and FIG. 1B is a sectional view obtained along line I-I′ of FIG. 1A according to example embodiments.

Referring to FIG. 1A, the electrical fuse device may include a cathode 100, an anode 200, and a fuse link 150. The cathode 100 may be separate from the anode. The fuse link 150 may be disposed between the cathode 100 and the anode 200. The fuse link 150 may link the cathode 100 and the anode 200. The shape of the cathode 100 and the anode 200 may be a rectangle, for example. Even though the shape of the cathode 100 and anode 200 in FIG. 1A are rectangle shaped, example embodiments are not limited thereto and may include other variations. For example, the cathode 100 and anode 200 may be square shaped, as well as any other size or ratio within the example embodiments. The width W1 of the cathode 100 may be larger than the width W2 of the anode 200. The width of the fuse link 150 may be smaller than the width of the cathode 100 and the anode 200. For example, the width of the fuse link 150 may be between several tens of nanometers (nm) to several hundreds nanometers (nm) and a length between several tens of nanometers (nm) and several micrometers (μm).

According to example embodiments, when a current exceeding a critical point flows through the fuse link 150, a particular region of the fuse link 150 may be blown due to an electromigration (EM) effect and a Joule heating effect. As the width of the fuse link 150 decreases and the length of the fuse link 150 increases, the fuse link 150 may be blown more easily.

Referring to FIG. 1B, the fuse link 150 may include a multi-metal layer structure. More particularly, the fuse link 150 may include a lower metal layer L1 and an upper metal layer L2 stacked sequentially on a semiconductor substrate (not shown). The resistance of the upper metal layer L2 may be lower than the resistance of the lower metal layer L1. The lower metal layer L1 may be a titanium (Ti) layer, a titanium nitride (TiN) layer, or a tantalum nitride (TaN) layer, while the upper metal layer L2 may be a tungsten (W) layer, an aluminium (Al) layer, or a copper (Cu) layer, for example. The multi-metal layer structure may be W/Tin, Al/Ti, or Cu/TaN structure, or example. However, the example embodiments are not limited thereto, and materials for forming the lower metal layer L1 and the upper metal layer L2 may vary.

Although not shown in FIG. 1B, a seed layer may further be located under the lower metal layer L1. For example, if the fuse link 150 has the W/TiN structure, the seed layer may be a Ti layer. Meanwhile, the cathode 100 and the anode 200 may include the multi-metal layer of the fuse link 150. An electrical fuse device including the multi-metal layer structure may be easily formed together with a metal gate or metal wiring of a cell region of a semiconductor substrate (not shown).

Although not shown in FIGS. 1A and 1B, the cathode 100 or the anode 200 may be connected to a sense circuit and a programming transistor. Because the sense circuit and the programming transistor are well known to one skilled in the art, a detailed description thereof will be omitted.

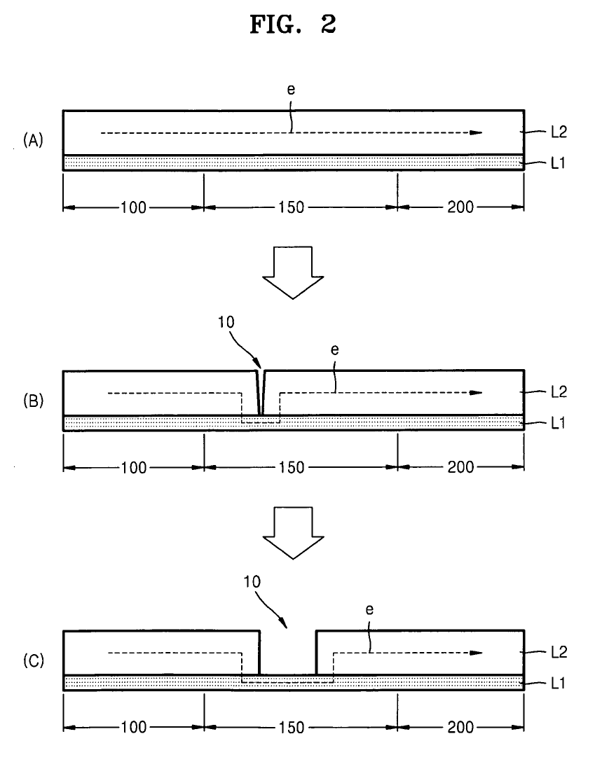

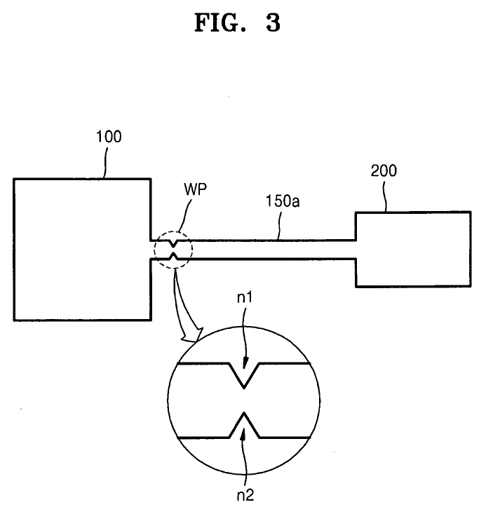

FIGS. 2A-2C are diagrams illustrating an operation for blowing the electrical fuse device of FIG. 1B.

Referring to FIG. 2A, when a current is applied from the anode 200 to the cathode 100, electrons (e) may move from the cathode 100 to the anode 200. At this point, because the upper metal layer L2 has a resistance lower than the lower metal layer L1, the electrons (e) may move through the upper metal layer L2.

The electrons (e) cause the EM and Joule heating effects in the upper metal layer L2, and thus a particular region of the upper metal layer L2 of the fuse link 150 may be cut, as shown in FIG. 2B. As a result, electrons (e) may flow through the lower metal layer L1, under a cut region 10, as shown in FIG. 2B. The cut region 10 may be widened due to the movement of the electrons (e), as shown in FIG. 2C.

According to example embodiments, because the electrons (e) are flowing through the upper metal layer L2, the upper metal layer L2 may be definitely cut. For example, even if a portion of the upper metal layer L2 remains in the cut region 10 in FIG. 2B, the EM and Joule effect may still apply to the remaining upper metal layer L2 due to the flow of the electrons (e) through the lower metal layer L1. Therefore, according to example embodiments, the problem of having the upper metal layer L2 remain in the cut region 10 may be prevented. A completely programmed fuse device is shown in FIG. 2C. Although not shown in FIG. 2, the lower metal layer L1 may be also cut according to example embodiments.

When a W layer is used as the upper metal layer L2, the size of a programming transistor connected to the cathode 100 or the anode 200 may be minimized because the W layer may require a relatively small programming current to be cut. For instance, the programming current may be less than 10 mA, for example. Therefore, an area occupied by a unitary fuse device corresponding to 1 bit may be reduced. As a result, the overall integration of a semiconductor device may be improved. Meanwhile, when either an Al layer or a Cu layer is used as the upper metal layer L2, the upper metal layer L2 may require a programming current higher than the W layer. Because the resistances of the Al layer or the Cu layer are lower than the W layer, a relatively high density current may be required to cut the Al layer or the Cu layer.

The resistance of a fuse device may be measured while the upper metal layer L2 is not cut, and may be referred to as a first resistance. The resistance of the fuse device may be measured after the upper metal layer L2 is cut and may be referred to as a second resistance. Both the first and second resistance may be measured by a sense circuit. If the first resistance differs significantly from the second resistance, a configuration of the sense circuit may be simplified, and thus the area occupied by the unitary fuse device may be reduced further as compared to a case in which the difference between the first resistance and the second resistance is less significant.

FIG. 3 is a plan view of an electrical fuse device according to example embodiments. The electrical fuse device may be a variation of the electrical fuse device shown in FIG. 1A.

Referring to FIG. 3, a fuse link 150a may include a weak point WP. The weak point WP may be a region having a width relatively smaller than the other regions of the fuse link 150a. The weak point WP may be formed by two notches n1 and n2, which are formed at both side surfaces of the fuse link 150a. The two notches n1 and n2 may be formed such that the two notches n1 and n2 are symmetrical with respect to the lengthwise direction of the fuse link 150a. Even though the notches n1 and n2 are V-shaped in FIG. 3, example embodiments are not limited thereto. For example, the notches n1 and n2 may be u-shaped or square shaped, for example. The weak point WP may be formed by using a lithography method using an optical proximity correction (OPC), for example. As a result, current may be relatively dense at the weak point WP, and thus the weak point WP may be easily cut, that is, blown electrically. A location of the weak point WP may be closer to the cathode 100 than to the anode 200. Because greater eddy currents occur closer to the cathode 100 than to the anode 200 in the fuse link 150a, the weak point WP may be blown easier when the weak point WP is located nearer to the cathode 100 than to the anode 200.

FIG. 4 is a plan view of an electrical fuse device according to another example embodiment. The difference between the electrical fuse device shown in FIG. 3 and the electrical fuse device shown in FIG. 4 is the shape of the anodes.

Referring to FIG. 4, an anode 200a may include a first regional linked to the fuse link 150a and a second region a2 extending from the first regional. The width of the first regional may increase gradually from the boundary between the fuse link 150a and the first regional to the boundary between the first regional and the second region a2. The width of the second region a2 may be uniform. The first regional may have a width that is substantially the same as the fuse link 150a at a boundary between the first regional and the fuse link 150a. Accordingly, because the first regional increases in width from the boundary between the fuse link 150a and the first regional to the boundary between the first regional and the second region a2, a density of current flowing from the fuse link 150a to the first regional may vary gradually. Therefore, the EM from the fuse link 150a to the anode 200a may be easily achieved. Meanwhile, the cathode 100 may have a structure in which the EM from the cathode 100 to the fuse link 150a is not easily achieved. In other words, the cathode 100 may have a structure capable of inducing relatively significant change in the density of current between the cathode 100 and the fuse link 150a. For example, a relatively significant change of the width between the cathode 100 and the fuse link 150a may be preferable. Accordingly, when the change of the width between the fuse link 150a and the cathode 100 is relatively significant and the change of the width between the fuse link 150a and the anode 200a is gradual, the EM from the cathode 100 to the fuse link 150a may not as occur as easy as the EM from the fuse link 150a to the anode 200a. As a result, the fuse link 150a can be easily cut.

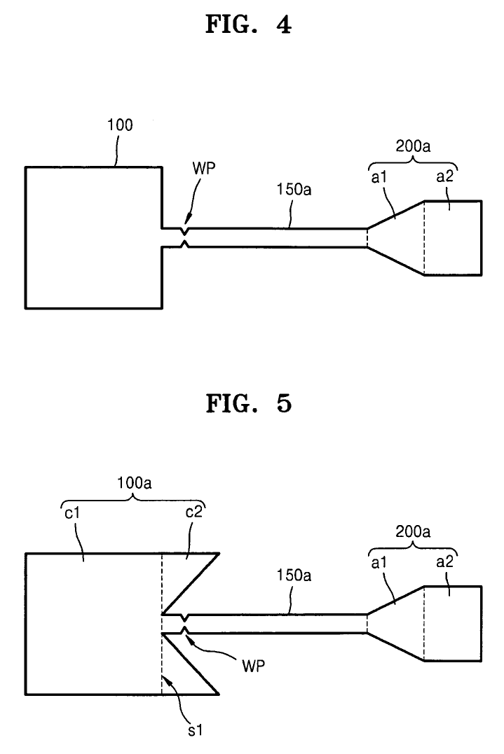

FIG. 5 is a plan view of an electrical fuse device according to another example embodiment. The difference between the electrical fuse device shown in FIG. 4 and the electrical fuse device shown in FIG. 5 may be the shape of the cathodes.

Referring to FIG. 5, a cathode 100a may include a first region c1 and a second region c2. The first region c1 may have a shape of a rectangle with a fixed width. The fuse link 150a may contact the center of a first side surface s1 of the first region c1. The second region c2 may extend toward the anode 200a from the first side surface s1 at both sides of the fuse link 150a. According to an example embodiment, the second region c2 may be shaped as a triangle, as shown in FIG. 5. However, example embodiments are not limited thereto. For example, the second region may be shaped according to shapes other than a triangle within example embodiments of the present application. Accordingly, if the cathode 100a further includes the second region c2, a density of current between the cathode 100a and the fuse link 150a may be changed more significantly.

The electrical fuse devices having the structures as shown in FIGS. 3 through 5 may have the cross-sectional structure as shown in FIG. 1B. However, an electrical fuse device according to another example embodiment may include the planar structure as shown in FIGS. 3 through 5 and a conventional cross-sectional structure. According to example embodiments, the efficiency of the electrical fuse device may be improved due to the characteristics of the planar structure, as shown in FIGS. 3 through 5.

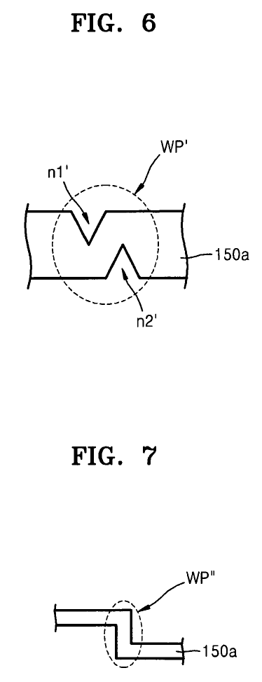

According to other example embodiments, electrical fuse devices may have the weak point WP shown in FIGS. 3 through 5. In addition, a structure of the weak point WP may be reflected in FIGS. 6 and 7 according to example embodiments.

FIG. 6 illustrates a weak point WP′ according to another example embodiment. Referring to FIG. 6, a weak point WP′ may be formed by two notches n1′ and n2′ formed at side surfaces of the fuse link 150a in a V-shape form such that the two notches n1′ and n2′ are diagonally opposite to each other. Even though the notches n1′ and n2′ are V-shaped in FIG. 6, example embodiments are not limited thereto. For example, the notches n1′ and n2′ may be shaped otherwise such as u-shaped or square shaped, for example.

FIG. 7 illustrates a weak region WP″ of the fuse link 150a according to another example embodiment. Referring to FIG. 7, a weak region WP″ of the fuse link 150a may be a bent region. The width of the fuse link 150a may be uniform throughout the fuse link 250, except the width of the fuse link 150a may become narrower in the bent region. Because current is concentrated at edges of the bent region, the bent region may be electrically cut more easily.

The fuse devices according to example embodiments described above may be arranged in plural to form a second-dimensional array, and may be applied for various purposes to semiconductor memory devices, logic devices, microprocessors, field programmable gate arrays (FPGA), very large scale integration (VLSI) circuits, for example.

While the present application has been particularly shown and described with reference to the example embodiments thereof, it will be understood by one of ordinary skill in the art that various changes in form and details may be made therein without departing from the spirit and scope of the present application as defined by the following claims. For example, one of ordinary skill in the art understands that structures and components of the electrical fuse devices shown in FIGS. 1A, 1B, and FIGS. 3 through 7 may be changed and varied. For example, the position of the lower metal layer L1 and the position of the upper metal layer L2 may be interchanged, the cathodes 100 and 100a and the anodes 200 and 200a may be similarly sized, and the shapes of the cathodes 100 and 100a, the anodes 200 and 200a, and the fuse links 150 and 150a may vary.

What is claimed is:

1. An electrical fuse device comprising:
a cathode;
an anode; and
a fuse link linking the cathode and the anode, the fuse link including a multi-metal layer structure.

2. The electrical fuse device of claim 1, wherein the fuse link includes:
a first metal layer including a first resistance; and
a second metal layer stacked on the first metal layer and including a second resistance, the first resistance being different from the second resistance.

3. The electrical fuse device of claim 2, wherein one of the first metal layer and the second metal layer, having a lower resistance than the other one, includes one of a W (tungsten) layer, an Al (aluminum) layer, and a Cu (copper) layer.

4. The electrical fuse device of claim 2, wherein one of the first metal layer and the second metal layer, having a higher resistance than the other one, includes one of a Ti (titanium) layer, a TiN (titanium nitride) layer, and a TaN (tantalum nitride) layer.

5. The electrical fuse device of claim 1, wherein a structure of the cathode and the anode is the multi-metal layer structure.

6. The electrical fuse device of claim 1, wherein the fuse link includes a weak point, the weak point being a region at which electrical blowing is performed easier than other regions of the fuse link.

7. The electrical fuse device of claim 6, wherein the weak point includes a first notch and a second notch, the first and second notches being on each side of the fuse link.

8. The electrical fuse device of claim 7, wherein the first and second notches are diagonally opposite to each other.

9. The electrical fuse device of claim 6, wherein the weak point is closer to the cathode than to the anode.

10. The electrical fuse device of claim 6, wherein the weak point is a bent region.

11. The electrical fuse device of claim 6, wherein the weak point has a width smaller than the widths of the other regions of the fuse link.

12. The electrical fuse device of claim 1, wherein the cathode and the anode include a structure in which electromigration from the fuse link to the anode is performed easier than that from the cathode to the fuse link.

13. The electrical fuse device of claim 12, wherein portions of the cathode extend toward the anode, the portions of the cathode being at both sides of the fuse link.

14. The electrical fuse device of claim 12, wherein the anode includes a first region linked to the fuse link, wherein the width of the first region gradually increases away from a boundary between the fuse link and the first region.

15. The electrical fuse device of claim 14, wherein the anode further includes a second region extending from the first region.

16. The electrical fuse device of claim 1, wherein the shape of the anode is a rectangle with a fixed width.

17. An electrical fuse device comprising:
a cathode and an anode formed apart from each other; and
a fuse link linking the cathode and the anode, the fuse link including a weak point as a region at which electrical blowing is performed easier than other regions of the fuse link, the weak point being closer to the cathode than to the anode.

18. The electrical fuse device of claim 17, wherein the weak point has a width smaller than the widths of the other regions of the fuse link.

19. The electrical fuse device of claim 17, wherein the weak point is a bent region.

20. The electrical fuse device of claim 17, wherein the cathode and the anode have a structure in which electromigration from the fuse link to the anode is performed easier than that from the cathode to the fuse link.

21. The electrical fuse device of claim 17, wherein portions of the cathode extend toward the anode, the portions of the cathode being at both sides of the fuse link.

22. The electrical fuse device of claim 17, wherein the anode includes a first region linked to the fuse link, wherein the width of the first region increases away from a boundary between the fuse link and the first region.

23. The electrical fuse device of claim 22, wherein the anode further includes a second region extending from the first region.

24. The electrical fuse device of claim 17, wherein the shape of the anode is a rectangle with a fixed width.
